(19) United States
(12) Patent Application Publication
(10) Pub. No.: US 2002/0048097 A1
(43) Pub. Date: Apr. 25, 2002

(54) Polygon mirror

(76) Inventor: Yutaka Ishizuka, Nagano (JP)

Correspondence Address: HOGAN & HARTSON L.L.P., 500 S. GRAND AVENUE, SUITE 1900, LOS ANGELES, CA, 90071-2611, US

(21) Appl. No.: 09/972,187

(22) Filed: Oct. 4, 2001

(30) Foreign Application Priority Data
Oct. 17, 2000 (JP) 2000-316582

(51) Int. Cl. G02B 5/08

(52) U.S. Cl. 359/855

(57) ABSTRACT

A polygon mirror is formed from a sintered body, wherein the sintered body is formed by firing a mixed powder containing copper powder as a primary component, and having a weight density of about 75% or more in ratio to pure copper.

### BACKGROUND OF THE INVENTION

1. Field of the Invention

The present invention generally relates to a polygon mirror used in optical deflectors found in laser printers and digital copiers.

2. Description of Related Art

A polygon mirror has a body with a regular polygonal contour whose outer circumference surfaces provide reflective surfaces. As the body rotates, the reflective surfaces that reflect light beams, e.g., laser light, switch sequentially as rotation takes place, such that operations such as reciprocating scanning of a light beam within a certain range can be performed. Polygon mirrors can be manufactured by, for example, a method to cut a metal material using a milling machine or lathe in order to form a blank material having a shape close to the final product, and to render a finish on the blank material; or a method to punch a rolled material using a blanking press in order to form a blank material, and to render a finish on the blank material.

The applicant of the present invention proposed a method of manufacturing a blank material for a polygon mirror using a sintered material whose primary component is an aluminum alloy powder. According to this method, the blank material for a polygon mirror can be manufactured with high precision by press-molding the aluminum alloy powder and firing it. Further, this method has the added advantages of an extremely low material loss and a potential for high productivity.

In recent years, the use of polygon mirrors having a higher reflective rate has been desired in optical deflectors used in laser printers and digital copiers. For example, one demand for the reflective rate of reflective surfaces of a polygon mirror is 85% or more. This is due to the fact that when the reflective rate is low, the amount of light lost accompanying reflection on the reflective surfaces must be compensated by increasing the output from a light source, which causes problems such as a shortened life of the light source or the need to install a light source with higher output.

However, it is sometimes difficult to obtain a reflective rate of 85% or more from the reflective surfaces formed on the outer circumference of polygon mirrors comprising a sintered body made from aluminum alloy. This is because microscopic pores are prone to form on the reflective surfaces of polygon mirrors comprising a sintered body made from aluminum alloy, which makes it difficult to increase the reflective rate of reflective surfaces.

### SUMMARY OF THE INVENTION

It is an object of the present invention is to provide a polygon mirror comprising a sintered body with a high reflective rate, in view of the problem described above.

In accordance with one embodiment of the present invention, a polygon mirror may be formed from a sintered body, which is formed by firing a mixed powder whose primary component is copper powder, wherein the weight density of the sintered body is 75% or more in ratio to pure copper.

When using a sintered body whose primary component is copper powder, the reflective surfaces formed by such a sintered body have an extremely high reflective rate for semiconductor lasers of 700 nm or more, and especially for laser beams whose wavelength band includes a wavelength of 780 nm, as compared to its reflective rate for semiconductor lasers having wavelengths of less than 700 nm. As a result, it would be easy to manufacture a polygon mirror equipped with reflective surfaces having a high reflective rate, and suitable for use on optical equipment, into which semiconductor laser is assembled as a light source.

In such a case, the weight density of the sintered body may preferably be between about 80% and 93% in ratio to pure copper, and more preferably be about 90%. When this requirement is met, the reflective rate of reflective surfaces of a polygon mirror can be increased and the strength and rigidity of the polygon mirror itself are enhanced, which leads to better weight and rotation balances.

Further, in accordance with one embodiment of the present invention, the mixed powder may contain tin powder in the range of about 7 wt. % to 20 wt. % as an additive. More preferably, the mixed powder may contain about 10 wt. % of tin powder. Tin works as a binder for the sintered material, and the sintered body's strength diminishes when the amount of tin contained is less than 7 wt. %, while the reflective rate of reflective surfaces diminishes when the amount of tin contained exceeds 20 wt. %.

In accordance with one embodiment of the present invention, the mixed powder may contain a nickel powder in the range of about 0.1 wt. % to 5 wt. %. More preferably, the mixed powder may contain about 1.0 wt. % in the nickel powder. Nickel works to fill in the microscopic pores on the surface of the sintered body, i.e., the microscopic pores on the reflective surfaces formed, and the sintered body's strength diminishes when the amount of nickel contained is less than 0.1 wt. %, while the reflective rate of reflective surfaces diminishes when the amount of nickel contained exceeds 5 wt. %.

In accordance with another embodiment of the present invention, an outer circumference part of a polygon mirror is formed from a sintered body, wherein the outer circumference part of the polygon mirror forms the mirror's reflective surfaces, and an inner part of the polygon mirror is formed from a base material made of ceramic product. In other words, a polygon mirror may be formed from a base material, a cylindrical member comprising a sintered material forming a unitary structure with the base material through insert molding on the outer circumference of the base material, and a plurality of reflective surfaces formed by rendering a mirror finish on the polygonal outer circumference surfaces of the cylindrical member. Materials having a structure described above can be used as the sintered material.

In a polygon mirror having such a composite construction, various effects can be obtained depending on the selection of the base material properties, in addition to the actions and effects gained when the sintered body has as its primary component copper powder. For example, by selecting a light material a polygon mirror with generally small inertia can be manufactured. Alternatively, by using an inexpensive material, the cost of polygon mirrors can be further reduced.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

FIG. 1 is a perspective view showing a polygon mirror in accordance with an embodiment of the present invention.

FIG. 2 shows a summary process chart showing the manufacturing processes for the polygon mirror in FIG. 1.

FIG. 3 shows a plan view showing a polygon mirror in accordance with another embodiment of the present invention.

### EMBODIMENT OF THE INVENTION

An example of a polygon mirror in accordance with an embodiment of the present invention is described below with references to the accompanying figures.

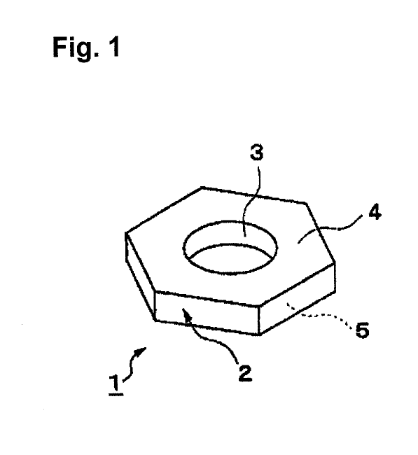

FIG. 1 is a perspective view of a polygon mirror in accordance with the embodiment of the present invention. As the figure shows, a polygon mirror 1 has a regular hexagonal contour with a generally constant thickness. The six surfaces of the regular hexagonal contour that define its outer circumference surfaces are reflective surfaces 2. A mounting hole 3 is formed in the center to be used for mounting the polygon mirror on a rotary shaft (not in the figure). It is noted that the shape of the polygon mirror to which the present invention can be applied is not limited to a regular hexagonal contour and may be other regular polygons.

The polygon mirror 1 having the above structure is formed from a sintered body. The sintered body is made by firing a mixed powder whose primary component is copper powder and has a weight density of 75% or more in ratio to pure copper. The weight density may preferably be in the range of about 80% to 93% in ratio to pure copper, and more preferably be about 90%. When this requirement is met, the reflective rate of the reflective surfaces 2 of the polygon mirror 1 can be 85% or more. In addition, by increasing the weight density, the strength and rigidity of the polygon mirror 1 itself are enhanced, which leads to better weight and rotary balances.

Here, the mixed powder for sintering according to the present embodiment may contain tin powder in the range of about 7 wt. % to 20 wt. % as an additive to the copper powder. Tin works as a binder for the sintered material and no effects can be obtained from its addition when the amount of tin contained is less than 7 wt. %, and, on the other hand, the reflective rate of the reflective surfaces 2 diminishes when the amount of tin contained exceeds 20 wt. %; both are therefore undesirable. It is especially desirable for the mixed powder to contain about 10 wt. % in the tin powder, since this would result in a polygon mirror with reflective surfaces having a high reflective rate and with high strength and rigidity.

Additionally, the mixed powder for sintering according to the present embodiment may contain nickel powder in the range of about 0.1 wt. % and 5 wt. %. Nickel works as a binder, as well as to fill in the microscopic pores on the surface of the sintered body, i.e., the microscopic pores that appear on the reflective surfaces 2 formed. The sintered body's strength diminishes when the amount of nickel contained is less than 0.1 wt. %, while the reflective rate of reflective surfaces diminishes when the amount of nickel contained exceeds 5 wt. %; both are therefore undesirable. In a preferred embodiment, the mixed powder may contain about 1.0 wt. % in the nickel powder, since this would result in a polygon mirror with reflective surfaces having a high reflective rate and with high strength and rigidity.

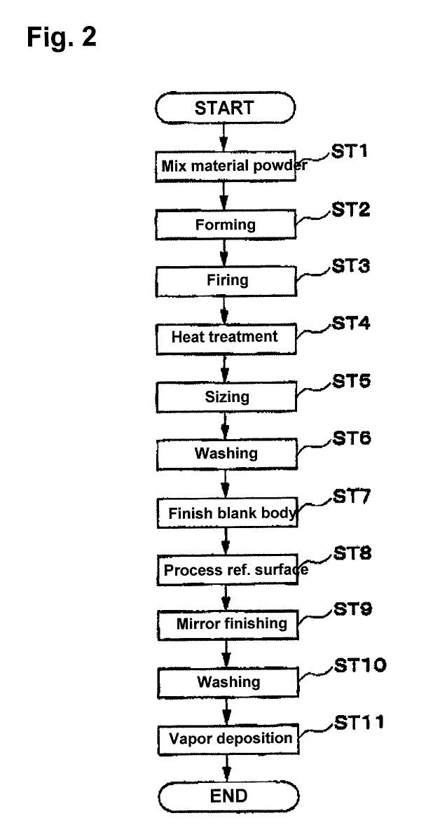

Next, an example of a method for manufacturing a polygon mirror 1 by sintering a mixed powder whose primary component is copper is described with reference to the summary flow chart in FIG. 2.

First, 10 wt. % in tin powder, 1.0 wt. % in nickel powder and other additives are mixed with copper powder to make a mixed metal powder for sintering, whose primary component is the copper powder and whose weight density is approximately 89% (step ST 1: Mix raw powder materials). Next, the mixed metal powder is put into a molding die cast and pressure-formed to obtain a molded body having an identical shape with a blank material for the polygon mirror 1 (step ST 2: Forming). The molded body is sintered in vacuum to obtain a sintered body (step ST 3: Firing). The sintered body is then quenched to increase its hardness (step ST 4: Heat treatment), and sized so that the surface that would become the inner circumference surface of the mounting hole 3 formed in the center of the polygon mirror 1 is subject to a plastic-work to improve the roundness of the mounting hole (step ST 5: Sizing). By washing the post-sizing sintered body in an ultrasonic washer, a blank material with a shape close to the final shape of the polygon mirror 1 can be obtained (steps ST 6 & 7: Washing and Finish blank body).

Next, the two end surfaces of the blank material (surfaces that correspond to surfaces 4 and 5 of the polygon mirror) are ground (step ST 8: Reference surface processing), followed by a mirror finish on the outer circumference surfaces of the blank material (the surfaces that become each of the reflective surfaces 2 of the polygon mirror) to form reflective surfaces 2 (step ST 9: Mirror finishing). The blank material whose surfaces have been finished thus is washed again (step ST 10: Washing), after which a protective film made of glass is vacuum-vapor deposited on the outer circumference surfaces that become the reflective surfaces to obtain the polygon mirror 1 (step ST 11: Vacuum-vapor deposition).

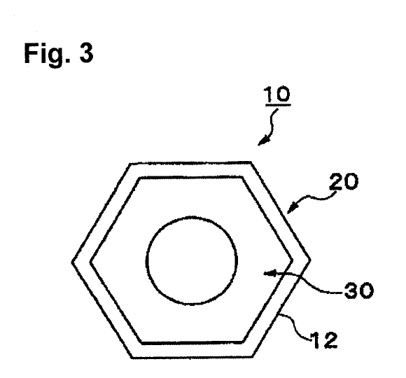

Next, FIG. 3 shows a polygon mirror in accordance with another embodiment of the present invention. A polygon mirror 10 shown in this figure includes a sintered body 20 to form its outer circumference part, which in turn forms reflective surfaces 12, and a base material 30 made of ceramic to form its inner part, and has a composite structure in which these components form a unitary structure.

In other words, the sintered body 20 is a cylindrical body in a regular hexagonal shape. The base material 30 has a regular hexagonal contour with a constant thickness, and on the outer circumference of the base material 30 is the sintered body 20, which forms a unitary structure with the base material 30 through insert molding. The sintered body 20 is a sintered body whose primary component is a copper powder, as in the earlier embodiment.

In a polygon mirror 10 having such a composite structure, various effects can be obtained depending on the selection of the base material properties, in addition to the actions and effects gained when the sintered body has as its primary component a copper powder. For example, in the present embodiment, a thin, metal sintered body forms a unitary structure with a light ceramic base material on the outer circumference of it, which can create a generally light weight polygon mirror. Consequently, a polygon mirror with generally small inertia can be achieved. Or, by using an inexpensive material to make the base material, the polygon mirror's cost can be further reduced.

As explained above, in a polygon mirror according to the present invention, at least the outer circumference part, which forms the reflective surfaces, is made with a sintered body whose primary component is copper powder. As a result, a polygon mirror equipped with reflective surfaces having a high reflective rate can be easily achieved compared to one comprising a sintered body made of aluminum alloy.

Further, by increasing the weight density of the sintered body in ratio to pure copper, a polygon mirror with high strength and hardness, as well as good and uniform weight and rotation balances, can be achieved.

Moreover, by including in the copper powder appropriate amounts of tin and/or nickel as additives, a polygon mirror with superior strength and hardness, as well as reflective surfaces with a high reflective rate, can be achieved.

In addition to these, due to the fact that the polygon mirror uses a sintered body, advantages such as reduced material waste, simplified process steps, and stable processing precision can be obtained; as a result, the polygon mirror can be mass produced with good yield and at low cost.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A polygon mirror comprising a sintered body, wherein the sintered body is formed from a mixed powder containing copper powder as a primary component and has a weight density of about 75% or more in ratio to pure copper.

2. A polygon mirror according to claim 1, wherein the mixed powder contains tin powder in the range of about 7 wt. % to 20 wt. %.

3. A polygon mirror according to claim 1, wherein the mixed powder contains nickel powder in the range of about 0.1 wt. % to 5 wt. %.

4. A polygon mirror according to claim 1, wherein the weight density of the sintered body is in the range of about 80% to 93% in ratio to pure copper.

5. A polygon mirror according to claim 4, wherein the mixed powder contains tin powder in the range of about 7 wt. % to 20 wt. %.

6. A polygon mirror according to claim 4, wherein the mixed powder contains nickel powder in the range of about 0.1 wt. % to 5 wt. %.

7. A polygon mirror according to claim 4, wherein the weight density of the sintered body is about 90% in ratio to pure copper.

8. A polygon mirror according to claim 7, wherein the mixed powder contains about 10 wt. % in a tin powder and about 1.0 wt. % in a nickel powder.

9. A polygon mirror according to claim 1, further comprising a protective film vacuum-vapor deposited on reflective surfaces of the polygon mirror.

10. A polygon mirror according to claim 1, wherein reflective surfaces of the polygon mirror have a higher reflective rate for laser light with wavelength of 700 nm or more, compared to that for laser light with wavelength of less than 700 nm.

11. A polygon mirror comprising:
a base material;
a cylindrical member formed from a sintered material connected in a unitary structure to an outer circumference of the base material; and
a plurality of mirror-finished reflective surfaces provided on polygonal outer circumference surfaces of the cylindrical member;
wherein the sintered material is formed by firing a mixed powder containing copper powder as a primary component and has a weight density of about 75% or more in ratio to pure copper.

12. A polygon mirror according to claim 11, wherein the mixed powder contains tin powder in the range of about 7 wt. % to 20 wt. %.

13. A polygon mirror according to claim 11, wherein the mixed powder contains nickel powder in the range of about 0.1 wt. % to 5 wt. %.

14. A polygon mirror according to claim 11, wherein the sintered body has a weight density in the range of about 80% to 93% in ratio to pure copper.

15. A polygon mirror according to claim 14, wherein the mixed powder contains tin powder in the range of about 7 wt. % to 20 wt. %.

16. A polygon mirror according to claim 14, further comprising a mixed powder that contains a nickel powder in the range of about 0.1 wt. % to 5 wt. %.

17. A polygon mirror according to claim 14, wherein the weight density of the sintered body is about 90% in ratio to pure copper.

18. A polygon mirror according to claim 17, wherein the mixed powder contains about 10 wt. % in tin powder and about 1.0 wt. % in nickel powder.

19. A polygon mirror according to claim 11, wherein the base material is made of ceramic.

20. A polygon mirror according to claim 11, further comprising a protective film vacuum-vapor deposited on reflective surfaces of the polygon mirror.

21. A polygon mirror according to claim 11, wherein reflective surfaces of the polygon mirror have a higher reflective rate for laser light with wavelength of 700 nm or more, compared to that for laser light with wavelength of less than 700 nm.
